(19) United States
(12) Patent Application Publication
(10) Pub. No.: US 2015/0230279 A1
(43) Pub. Date: Aug. 13, 2015

(54) METHOD AND APPARATUS FOR ALLOCATING IP ADDRESS OF MACHINE-TYPE COMMUNICATION TERMINAL

(71) Applicant: ELECTRONICS AND TELECOMMUNICATIONS RESEARCH INSTITUTE, Daejeon (KR)

(72) Inventors: Namsuk LEE, Daejeon (KR); Yong Seouk CHOI, Daejeon (KR)

(73) Assignee: ELECTRONICS AND TELECOMMUNICATIONS RESEARCH INSTITUTE, Daejeon (KR)

(21) Appl. No.: 14/615,059

(22) Filed: Feb. 5, 2015

(30) Foreign Application Priority Data
Feb. 13, 2014 (KR) 10-2014-0016914

(51) Int. Cl. H04W 76/02; H04W 4/00; H04L 29/12

(52) U.S. Cl. CPC H04W 76/021; H04L 61/2007; H04W 4/005

(57) ABSTRACT

An access service network (ASN) gateway allocates one of IP addresses reserved for MTC communication on the basis of attachment information of a terminal, allocates port numbers by the number of ports requested by the terminal among unallocated port numbers belonging to the allocated IP address, and transmits the allocated IP address and port numbers to the terminal.

### CROSS-REFERENCE TO RELATED APPLICATION

This application claims priority to and the benefit of Korean Patent Application No. 10-2014-0016914 filed in the Korean Intellectual Property Office on Feb. 13, 2014, the entire contents of which are incorporated herein by reference.

### BACKGROUND OF THE INVENTION

(a) Field of the Invention

The present invention relates to machine-type communication (MTC), and more particularly, to a method and apparatus for allocating an Internet protocol (IP) address and ports of an MTC terminal.

(b) Description of the Related Art

MTC refers to data communication between machines without human interference or interaction. MTC may be used in various applications such as those related to smart metering of electric power, gas, water, and the like, as well as vehicle management, stores, game machines, and the like.

In order for an MTC terminal to perform data communication with an MTC server or a different MTC terminal, the MTC terminal needs to perform an initial network attachment procedure. Upon completing terminal registration in a network through the network attachment procedure, the MTC terminal is allocated an IP address through a dynamic host configuration protocol (DHCP).

However, since tens of thousands of terminals may exist in a region managed by a single base station or an access service network (ASN) gateway, allocation of an IP address to each MTC terminal may cause a shortage of IP addresses.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for allocating an Internet protocol (IP) address of a machine-type communication (MTC) having advantages of solving a problem of shortage of IP addresses of MTC terminals.

An exemplary embodiment of the present invention provides an apparatus for allocating an IP address of a machine-type communication (MTC) terminal. The apparatus for allocating an IP address of an MTC terminal may include a receiver, an allocator, and a transmitter. The receiver receives attachment information of the terminal. The allocator may allocate one of Internet protocol (IP) addresses reserved for MTC communication on the basis of the attachment information of the terminal and allocate port numbers by the number of ports requested by the terminal among port numbers belonging to the allocated IP address. The transmitter may transmit the allocated IP address and the allocated port numbers to the terminal.

The attachment information may include MTC-type information indicating whether the terminal is an MTC-type terminal and the number of required ports.

When the terminal is an MTC-type terminal on the basis of the MTC-type information, the allocator may allocate one of the IP addresses reserved for MTC communication.

The attachment information of the terminal may be transmitted from the terminal to a base station (BS) through a registration request message, and may be received by the BS through an attachment request message.

The allocated IP address and the port numbers may be transmitted to the BS through an attachment response message in response to the attachment request message, and may be transmitted to the terminal by the BS through a registration response message in response to the registration request message.

On the basis of a request for additional ports from the terminal, the allocator may allocate port numbers by the number of ports additionally requested by the terminal among unallocated port numbers belonging to the IP address allocated to the terminal, and the transmitter may transmit the allocated port numbers to the terminal.

The receiver may receive the request for additional ports from the terminal, and the request for additional ports may include the IP address allocated to the terminal and the number of additionally required ports.

Another embodiment of the present invention provides a method for allocating an IP address of a machine-type communication (MTC) terminal by an access service network (ASN) gateway. The method for allocating an IP address of an MTC terminal may include: receiving attachment information of a terminal; allocating one of IP addresses reserved for MTC communication on the basis of the attachment information of the terminal; allocating port numbers by the number of ports requested by the terminal among unallocated port numbers belonging to the allocated IP address; and transmitting the allocated IP address and port numbers to the terminal.

The attachment information may include MTC-type information indicating whether the terminal is an MTC-type terminal and the number of required ports, and the allocating of an IP address may include selecting the IP address from the IP addresses reserved for MTC communication when the terminal is an MTC-type terminal.

The receiving may include: receiving an attachment request message from a base station (BS) which has received a registration request message, wherein the registration request message and the attachment request message may include the attachment information.

The transmitting may include: transmitting an attachment response message to the BS in response to the attachment request message; and transmitting, by the BS which has received the attachment response message, a registration response message to the terminal in response to the registration request message, wherein the attachment response message and the registration response message may include the allocated IP address and port numbers.

The method may further include: receiving a request for additional ports from the terminal; allocating port numbers by the number of ports additionally requested by the terminal, among unallocated port numbers belonging to the IP address allocated to the terminal, on the basis of the request for additional ports from the terminal; and transmitting the allocated port numbers to the terminal.

The request for additional ports may include the IP address allocated to the terminal and the number of additionally required ports.

### BRIEF DESCRIPTION OF THE DRAWINGS

FIG. 1 is a view illustrating a method for network attachment of a machine-type communication (MTC) terminal according to an exemplary embodiment of the present invention.

FIG. 2 is a flowchart illustrating a method for Internet protocol (IP) address allocation of an access service network (ASN) gateway according to an exemplary embodiment of the present invention.

FIG. 3 is a flowchart illustrating a method for a network registration of an MTC terminal according to an exemplary embodiment of the present invention.

FIG. 4 is a view illustrating an apparatus for allocating an IP address according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Hereinafter, a method and apparatus for allocating an Internet protocol (IP) address of a machine-type communication (MTC) terminal according to an exemplary embodiment of the present invention will be described in detail with reference to the accompanying drawings.

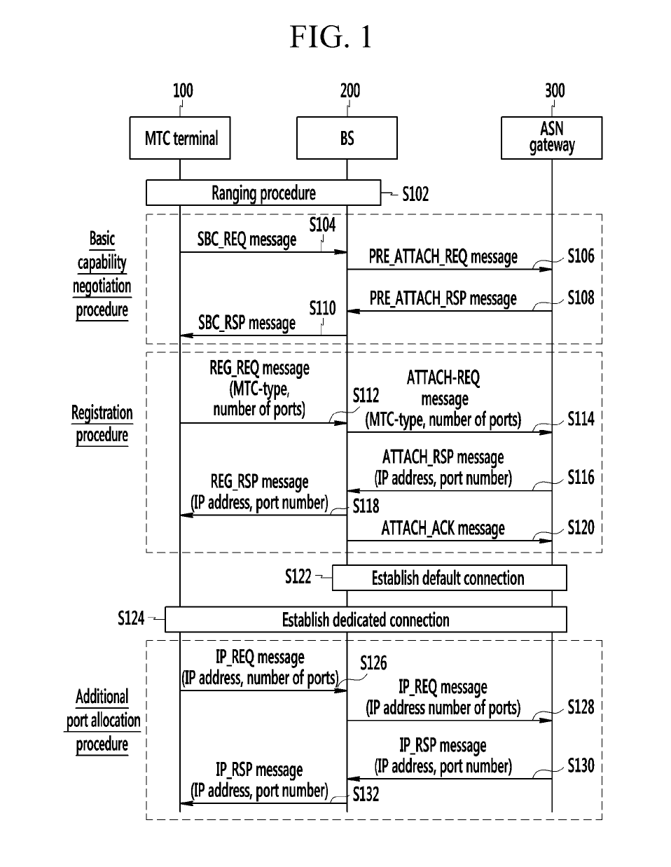

FIG. 1 is a view illustrating a method for network attachment of an MTC terminal according to an exemplary embodiment of the present invention.

Referring to FIG. 1, an MTC terminal 100 performs a network registration procedure for data transmission and reception.

In order to perform the network registration procedure, first, the MTC terminal 100 performs a ranging procedure.

When the ranging procedure is completed, the MTC terminal 100 performs a basic capability negotiation procedure with a base station (BS) 200. For the basic capability negotiation procedure, the MTC terminal 100 transmits a subscriber station basic capability request (SBC_REQ) for a basic capability negotiation to the BS 200 to provide information about the basic providing capability of the MTC terminal 100 (S104). The SBC_REQ message is a message that the MTC terminal 100 transmits for a negotiation regarding basic performance with the BS. The SBC_REQ message may include information regarding a modulation and coding scheme, or the like, that may be supported by the MTC terminal 100.

The BS 200 checks the information regarding the modulation and coding scheme, or the like, that may be supportable by the MTC terminal 100, and transmits a pre-attachment request (PRE_ATTACH_REQ) message to an access service network (ASN) gateway 300 (S106) to provide information regarding the modulation and coding scheme supportable by the MTC terminal to the ASN gateway 300.

The ASN gateway 300 transmits a pre-attachment response (PRE_ATTACH_RSP) message to the BS 200 in response to the PRE_ATTACH_REQ message (S108).

The BS 200 transmits a subscriber station basic capability response (SBC_RSP) message regarding the SBC_REQ message to the MTC terminal 100 to inform the MTC terminal 100 about common providing capability of the MTC terminal 100 and the BS 200 (S110).

As the MTC terminal 100 receives the SBC_RSP message from the BS 200, the basic capability negotiation process is completed.

When the basic capability negotiation process is completed, the MTC terminal 100 performs a registration procedure. The registration procedure is a process of enabling the BS 200 to manage the MTC terminal 100.

The MTC terminal 100 transmits a registration request (REG_REQ) message to the BS 200 (S112). The REG_REQ message may include attachment information of the MTC terminal 100. In particular, according to an exemplary embodiment, the attachment information of the MTC terminal may include MTC-type information indicating that the MTC terminal 100 is an MTC-type terminal and information regarding the number of TPC or UDP ports required for data communication.

The BS 200 extracts the attachment information of the MTC terminal 100 from the REG_REQ message. The BS 200 transmits the attachment information of the MTC terminal 100 to the ASN gateway 300 through an attachment request (ATTACH_REQ) message (S114). That is, the ATTACH_REQ message includes the MTC-type information of the MTC terminal 100 and the information regarding the number of TCP or UDP ports required for data communication.

The ASN gateway 300 serves to reserve IP addresses for MTC in advance and control allocation and distribution of port numbers. That is, the ASN gateway 300 allocates one IP address such that the IP address is shared by several MTC terminals, and allocates different port numbers to MTC terminals having the same IP address.

Upon receiving the ATTACH_REQ message from the BS, the ASN gateway 300 selectively allocates one of IP addresses reserved in advance for MTC, checks unallocated port numbers among port numbers belonging to the allocated IP address, and allocates TCP or UDP ports by the number of ports requested by the terminals. Here, the ASN gateway 300 may reserve IP addresses for MTC in advance, select one of IP addresses for MTC, allocate the one IP address such that the IP address may be shared by several MTC terminals, and allocate different port numbers to the MTC terminals having the same IP address.

The ASN gateway 300 transmits information of the allocated IP address and port numbers to the BS 200 through an attachment response (ATTACH_RSP) message in response to the ATTACH_REQ message (S116).

When the ATTACH_RSP message is received from the ASN gateway 300, the BS 200 registers the IP address and the port number of the MTC terminal 100 included in the ATTACH_RSP message, and transmits the IP address and port number allocated to the MTC terminal 100 to the MTC terminal 100 through a registration response (REG_RSP) message in response to the REG_REQ message (S118).

After transmitting the REG_RSP message to the MTC terminal 100, the BS 200 transmits an attachment acknowledge (ATTACH_ACK) message regarding the ATTACH_RSP message to the ASN gateway 300 (S120).

Upon receiving the REG_RSP message from the BS 200, the MTC terminal 100 may be allocated the IP address and the port number.

In general, when the registration procedure is completed, the terminal performs an IP allocation procedure through a dynamic host configuration protocol (DHCP), thus being allocated an IP address. However, according to an exemplary embodiment of the present invention, the MTC terminal 100 is allocated the IP address and the port number by the ASN gateway 300, while performing the registration procedure, and thus an IP allocation procedure through a DHCP may be omitted.

The BS 200 establishes a default connection with the ASN gateway 300 (S122).

The MTC terminal 100 establishes a dedicated connection with the ASN gateway 300 using the allocated IP address and port number (S124), and performs data communication with an MTC server or a different MTC terminal.

When an additional port is required for additional data communication, the MTC terminal 100 performs an additional port allocation procedure.

For the additional port allocation procedure, the MTC terminal 100 transmits information regarding the allocated IP address and the number of additional ports to the BS through an IP request (IP_REQ) message (S126), and the BS 200 transmits the IP_REQ message to the ASN gateway 300 (S128).

Upon receiving the IP_REQ message, the ASN gateway 300 checks unallocated port numbers among the port numbers belonging to the IP address, allocates port numbers by the number of additionally requested ports among the unallocated port numbers, and transmits information regarding the allocated port numbers to the BS through an IP response (IP_RSP) message (S130).

The BS 200 transmits an IP_RSP message to the MTC terminal 100 (S132).

In this manner, upon receiving the IP_RSP message, the MTC terminal 100 may be allocated additional port numbers.

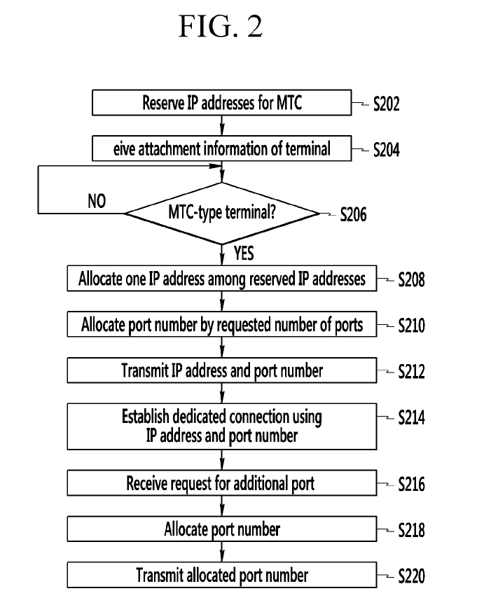

FIG. 2 is a flowchart illustrating a method for IP address allocation of an access service network (ASN) gateway according to an exemplary embodiment of the present invention.

Referring to FIG. 2, the ASN gateway 300 reserves certain IP addresses to be used for MTC in advance (S202).

The ASN gateway 300 receives attachment information of the MTC terminal 100 (S204). The attachment information is transmitted to the BS 200 through a REG_REQ message during a network attachment procedure, and may be transmitted from the BS 200 to the ASN gateway 300 through an ATTACH_REQ message.

The ASN gateway 300 determines whether the MTC terminal 100 is a machine-type terminal based on the attachment information (S206).

When the MTC terminal 100 is a machine-type terminal, the ASN gateway 300 selectively allocates a certain IP address among the IP addresses reserved for MTC (S208).

The ASN gateway 300 allocates port numbers by the number of ports requested by the MTC terminal 100 among unallocated port numbers belonging to the selected IP address (S210).

The ASN gateway 300 transmits information of the allocated IP address and the port numbers to the MTC terminal 100 (S212). The information of the IP address and the port numbers are transmitted to the BS 200 through an ATTACH_RSP message, and transmitted from the BS to the MTC terminal 100 through a REG_RSP message.

Thereafter, the ASN gateway 300 receives a request for establishing a dedicated connection using the IP address and the port numbers from the MTC terminal 100, and establishes a dedicated connection using the IP address and the port numbers with the MTC terminal 100 (S214). The ASN gateway 300 transmits and receives data to and from the MTC terminal using the established dedicated connection.

When an additional port allocation request is received from the MTC terminal 100 (S216), the ASN gateway 300 checks unallocated port numbers among port numbers belonging to the IP address allocated to the MTC terminal 100, and allocates the port numbers by the number of additionally requested ports among the unallocated port numbers (S218).

The ASN gateway 300 transmits information of the allocated port numbers to the MTC terminal 100 (S220). Here, the ASN gateway 300 may transmit the information of the allocated port numbers together with the IP address to the MTC terminal 100.

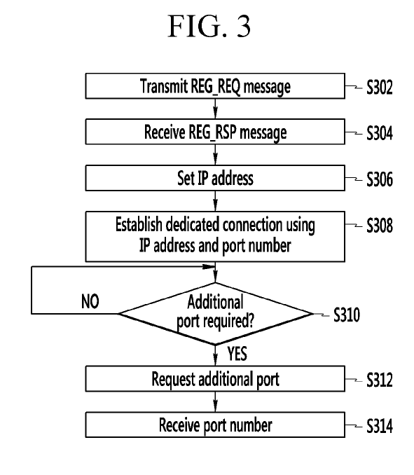

FIG. 3 is a flowchart illustrating a method for a network registration of an MTC terminal according to an exemplary embodiment of the present invention.

Referring to FIG. 3, the MTC terminal 100 transmits MTC-type information of the MTC terminal 100 and information regarding the number of UDP or TCP ports required for communication with an MTC server or a different MTC terminal (S302). The MTC terminal 100 may transmit the MTC-type information and the information regarding the number of ports through a REG_REQ message during a process of performing a network attachment procedure.

The MTC terminal 100 receives the REG_RSP message in response to the REG_REQ message (S304). The REG_RSP message includes an IP address and a port number allocated by the ASN gateway 300.

The MTC terminal 100 may set an IP address using the IP address included in the REG_RSP message (S306), and establishes a dedicated connection with the ASN gateway 300 using the IP address and the port number (S308). The MTC terminal 100 may transmit and receive data to and from an MTC server or a different MTC terminal using the dedicated connection established with the ASN gateway 300.

The MTC terminal 100 determines whether an additional UDP or TCP port is required (S310).

When an additional port is required, the MTC terminal 100 requests an additional port from the ASN gateway 300 (S312) and receives an additionally allocated port number from the ASN gateway 300 (S314). The request for an additional port is transmitted from the MTC terminal 100 to the ASN gateway 300 through an IP_REQ message. Also, the allocated port number is transmitted from the ASN gateway 300 to the MTC terminal 100 through an IP_RSP message.

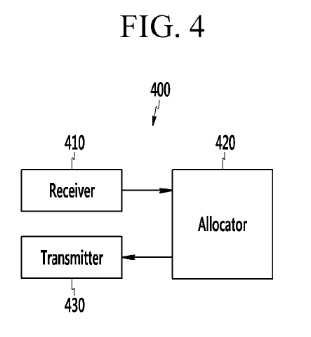

FIG. 4 is a view illustrating an apparatus for allocating an IP address according to an exemplary embodiment of the present invention.

Referring to FIG. 4, an IP address allocation device 400 includes a receiver 410, an allocator 420, and a transmitter 430.

The receiver 410 receives attachment information of a terminal which has requested attachment, and a request for additional ports from the terminal. The attachment information may include MTC-type information of the terminal which has requested attachment and information regarding the number of required ports. The request for additional ports may include information regarding an IP address of the terminal and the number of additionally required ports.

The allocator 420 reserves IP addresses for MTC and allocates and distributes an IP address and port numbers. On the basis of attachment information of the terminal which has requested attachment, when the terminal which has requested attachment is an MTC-type terminal, the allocator 420 selectively allocates an IP address from among the IP addresses reserved for MTC. The allocator 420 allocates port numbers by the number of ports requested by the terminal from among unallocated port numbers of the allocated IP address. Here, the allocator 420 may allocate an IP address such that the IP address is shared by several MTC terminals, and allocate different port numbers to MTC terminals having the same IP address. Also, according to the request for an additional port from the terminal, the allocator 420 allocates port numbers by the number of additionally requested ports from among unallocated port numbers of the IP address allocated to the corresponding terminal.

The transmitter 430 transmits the allocated IP address and port number to the corresponding terminal.

The IP address allocation device 400 may be an ASN gateway 300 or a component of the ASN gateway 300.

At least a partial function of the IP address allocation device method and device according to exemplary embodiments of the present invention described above may be implemented by hardware or software coupled to hardware. For example, a process formed as a central processing unit (CPU), a chip set, a microprocessor, and the like, may perform a function of the allocator 420, and a transceiver may perform a function of the receiver 410 and the transmitter 430.

According to an exemplary embodiment of the present invention, since a plurality of MTC terminals share the same IP address and perform data communication using different port numbers in MTC, IP address resources can be effectively used and a problem of shortage of IP addresses of MTC terminals can be solved.

The embodiments of the present invention may not necessarily be implemented only through the foregoing devices and methods, but may also be implemented through a program for realizing functions corresponding to the configurations of the embodiments of the present invention, a recording medium including the program, or the like, and such an implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for allocating an Internet protocol (IP) address of a machine-type communication (MTC) terminal, the apparatus comprising:
a receiver configured to receive attachment information of the terminal;
an allocator configured to allocate one of IP addresses reserved for MTC communication on the basis of the attachment information of the terminal and to allocate port numbers by the number of ports requested by the terminal among port numbers belonging to the allocated IP address.
a transmitter configured to transmit the allocated IP address and the allocated port numbers to the terminal.

2. The apparatus of claim 1, wherein the attachment information includes MTC-type information indicating whether the terminal is an MTC-type terminal and the number of required ports.

3. The apparatus of claim 2, wherein when the terminal is an MTC-type terminal on the basis of the MTC-type information, the allocator allocates one of the IP addresses reserved for MTC communication.

4. The apparatus of claim 1, wherein the attachment information of the terminal is transmitted from the terminal to a base station (BS) through a registration request message, and is received by the BS through an attachment request message.

5. The apparatus of claim 4, wherein the allocated IP address and the port numbers is transmitted to the BS through an attachment response message in response to the attachment request message, and is transmitted to the terminal by the BS through a registration response message in response to the registration request message.

6. The apparatus of claim 1, wherein, on the basis of a request for additional ports from the terminal, the allocator allocates port numbers by the number of ports additionally requested by the terminal among unallocated port numbers belonging to the IP address allocated to the terminal, and the transmitter transmits the allocated port numbers to the terminal.

7. The apparatus of claim 6, wherein the receiver receives the request for additional ports from the terminal, and the request for additional ports includes the IP address allocated to the terminal and the number of additionally required ports.

8. A method for allocating an Internet protocol (IP) address of a machine-type communication (MTC) terminal by an access service network (ASN) gateway, the method comprising:
receiving attachment information of a terminal;
allocating one of IP addresses reserved for MTC communication on the basis of the attachment information of the terminal;
allocating port numbers by the number of ports requested by the terminal among unallocated port numbers belonging to the allocated IP address; and
transmitting the allocated IP address and port numbers to the terminal.

9. The method of claim 8, wherein the attachment information includes MTC-type information indicating whether the terminal is an MTC-type terminal and the number of required ports, and the allocating of an IP address comprises selecting the IP address from the IP addresses reserved for MTC communication when the terminal is an MTC-type terminal.

10. The method of claim 8, wherein the receiving comprises receiving an attachment request message from a base station (BS) which has received a registration request message, wherein the registration request message and the attachment request message include the attachment information.

11. The method of claim 10, wherein the transmitting comprises:
transmitting an attachment response message to the BS in response to the attachment request message; and
transmitting, by the BS which has received the attachment response message, a registration response message to the terminal in response to the registration request message,
wherein the attachment response message and the registration response message include the allocated IP address and port numbers.

12. The method of claim 8, further comprising establishing a dedicated connection with the terminal by using the IP address and the port numbers of the terminal.

13. The method of claim 8, further comprising:
receiving a request for additional ports from the terminal;
allocating port numbers by the number of ports additionally requested by the terminal, among unallocated port numbers belonging to the IP address allocated to the terminal, on the basis of the request for additional ports from the terminal; and
transmitting the allocated port numbers to the terminal.

14. The method of claim 13, wherein the request for additional ports includes the IP address allocated to the terminal and the number of additionally required ports.
